(19) United States
(12) Patent Application Publication
(10) Pub. No.: US 2010/0088225 A1
(43) Pub. Date: Apr. 8, 2010

(54) METHODS, APPARATUSES, AND COMPUTER PROGRAM PRODUCTS FOR PROVIDING ELECTRONIC VALUE CERTIFICATES

(75) Inventor: Dan Forsberg, Helsinki (FI)

Correspondence Address: DITTHAVONG MORI & STEINER, P.C., 918 Prince Street, Alexandria, VA, 22314, US

(73) Assignee: Nokia Corporation

(21) Appl. No.: 12/245,186

(22) Filed: Oct. 3, 2008

(51) Int. Cl. G06F 17/30

(52) U.S. Cl. 705/39; 707/E17.032

(57) ABSTRACT

A method, apparatus, and computer program product are provided, which may provide electronic value certificates. An apparatus may include a processor configured to access a moblet template from a moblet template provider. The processor may also be configured to customize the moblet template to define a moblet. The processor may further be configured to add value to the moblet. The processor may additionally be configured to provide the moblet to a remote device. The processor may also be configured to receive an update to the moblet. Corresponding methods and computer program products are also provided.

### TECHNOLOGICAL FIELD

Embodiments of the present invention relate generally to mobile communication technology and, more particularly, relate to methods, apparatuses, and computer program products for providing electronic value certificates.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies as well as evolved computing devices making use of networking technologies continue to facilitate ease of information transfer and convenience to users. One area in which there is a demand to further improve the convenience to users is harnessing the connectivity and ready access to information available through expansion of networking technologies for the provision of electronic value certificates, such as, for example, electronic gift cards.

### BRIEF SUMMARY OF SOME EXAMPLES OF THE INVENTION

A method, apparatus, and computer program product are therefore provided, which may provide electronic value certificates. For example, a method, apparatus, and computer program product may be provided to enable, for example, the creation and sharing of electronic value certificates, which may be embodied as moblets as described herein. Users may be able to customize moblet templates and share moblets across a community. A moblet may allow for multiple users to contribute value to a moblet. Systems according to some embodiments of the invention may allow for recommending moblets, contacts, and/or groups of contacts to a user based at least in part upon the user's previous moblet usage.

In one exemplary embodiment, a method is provided which may include accessing a moblet template from a moblet template provider. The method may further include customizing the moblet template to define a moblet. The method may also include adding value to the moblet. The method may further include providing the moblet to a remote device. The method may additionally include receiving an update to the moblet.

In another exemplary embodiment, a computer program product is provided. The computer program product includes at least one computer-readable storage medium having computer-readable program instructions stored therein. The computer-readable program instructions may include first, second, third, fourth, and fifth program instructions. The first program instruction is for accessing a moblet template from a moblet template provider. The second program instruction is for customizing the moblet template to define a moblet. The third program instruction is for adding value to the moblet. The fourth program instruction is for providing the moblet to a remote device. The fifth program instruction is for receiving an update to the moblet.

In another exemplary embodiment, an apparatus is provided, which may include a processor configured to access a moblet template from a moblet template provider. The processor may also be configured to customize the moblet template to define a moblet. The processor may further be configured to add value to the moblet. The processor may additionally be configured to provide the moblet to a remote device. The processor may also be configured to receive an update to the moblet.

In another exemplary embodiment, a method is provided which may include receiving a request for access to a moblet template from a remote device. The method may further include providing access to the requested moblet template to the remote device. The method may additionally include receiving an indication of one or more customizations to the moblet template from the remote device. The method may also include customizing the moblet template to define a moblet based at least in part upon the received indication. The method may further include receiving an indication of value added to the moblet. The method may additionally include providing the moblet to a remote device. The method may also include receiving an update to the moblet. The method may further include updating the moblet based at least in part upon the received update.

In another exemplary embodiment, a computer program product is provided. The computer program product includes at least one computer-readable storage medium having computer-readable program instructions stored therein. The computer-readable program instructions may include first, second, third, fourth, fifth, sixth, seventh, and eighth program instructions. The first program instruction is for receiving a request for access to a moblet template from a remote device. The second program instruction is for providing access to the requested moblet template to the remote device. The third program instruction is for receiving an indication of one or more customizations to the moblet template from the remote device. The fourth program instruction is for customizing the moblet template to define a moblet based at least in part upon the received indication. The fifth program instruction is for receiving an indication of value added to the moblet. The sixth program instruction is for providing the moblet to a remote device. The seventh program instruction is for receiving an update to the moblet. The eighth program instruction is for updating the moblet based at least in part upon the received update.

In another exemplary embodiment, an apparatus is provided, which may include a processor configured to receive a request for access to a moblet template from a remote device. The processor may further be configured to provide access to the requested moblet template to the remote device. The processor may additionally be configured to receive an indication of one or more customizations to the moblet template from the remote device. The processor may also be configured to customize the moblet template to define a moblet based at least in part upon the received indication. The processor may further be configured to receive an indication of value added to the moblet. The processor may additionally be configured to provide the moblet to a remote device. The processor may also be configured to receive an update to the moblet. The processor may further be configured to update the moblet based at least in part upon the received update.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system for providing electronic value certificates according to an exemplary embodiment of the present invention;

FIG. 2 illustrates a block diagram of a system for providing electronic value certificates according to an exemplary embodiment of the present invention;

FIG. 3 illustrates a method of multiple users contributing value to an electronic value certificate according to an exemplary embodiment of the present invention; and

FIGS. 4-5 are flowcharts according to an exemplary method for defining a electronic value certificate according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

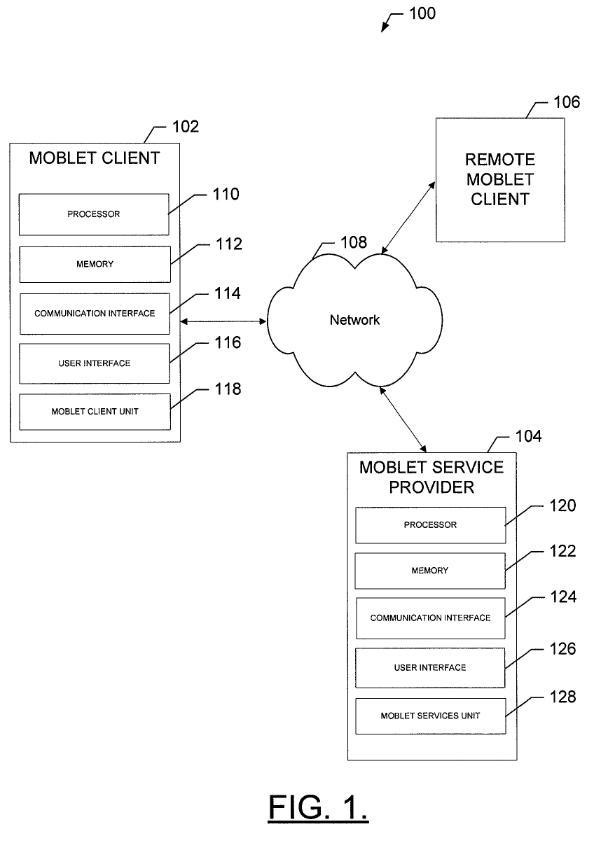

FIG. 1 illustrates a block diagram of a system 100 for providing electronic value certificates according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for providing electronic value certificates, numerous other configurations may also be used to implement embodiments of the present invention.

As used herein, “moblet” refers to an exemplary embodiment of an electronic value certificate and may serve as the basic unit of embodiments of systems and devices for providing electronic value certificates described herein. In this regard, a moblet may comprise an entity, such as may be defined by a software application, that may be configured to store information and be distributed and/or copied among users. The information may be monetary value, beneficiary information, group information, delivery/sender/receiver/user information, digital rights management information, advertisement, or any other value or information that can be claimed, added, delivered or consumed by a user. A moblet may be stored, shared, and/or used in computing devices (e.g., a mobile terminal), between computing devices or on a server computing device with a client connection (e.g. web page). A moblet may carry digital signatures or other sources for verification of moblet users. A moblet may carry history information on what one or more users have done with the moblet.

A moblet may further comprise one or more rules defining how the moblet may be used. The rules may define contextual information based triggers (e.g. date, time, location, user, recipient, and/or the like), which may define when and/or how a rule will be enacted and/or enforced. The rules may be linked with contextual based actions (e.g. number of actions, composition of action, history of actions, sending, receiving, storing, amending, and/or the like) such that the rules may define actions that may be performed on and/or with the moblet. These rules may be defined to take into account information carried by the moblet (e.g. lifetime, valid location area, monetary value, beneficiary, target group/user, and/or the like).

A moblet may be distributed from a moblet service provider to moblet clients, from moblet clients to other moblet clients (e.g., peer-to-peer), or both. Additionally or alternatively, moblets may be embodied on computing devices, such as servers, which may provide for the selection and/or download of moblets over a user interface accessible via a network, such as, for example, a web page.

A moblet may be embodied as a widget like e-coupon or electronic gift card that contains user specific information and optionally value that a user may use/consume with a moblet client to obtain goods or services. A moblet may be embodied as an active advertisement that may be updated and/or distributed based upon rules comprising the moblet.

A moblet may be embodied as a “betting card.” In this regard, a betting card may comprise a moblet containing value contributed by multiple users, each of which has selected a bet or option, e.g. an event outcome. The betting card may be customized with a betting rule that may define a precondition, event, or game of chance, the result of which may define distribution of the betting card's value to one or more of the users based at least in part upon the option(s) selected by the users. In this regard, a betting card may serve as an electronic gambling, book-making, and/or game application. For example, a betting card may be customized or otherwise configured to provide for multiple users to stake a wager on an outcome of a horse race and a betting rule may provide for the user that has correctly selected the winning horse to receive the combined wagers staked by the users. It will be appreciated that the wagers may be monetary or some other form of value, depending on the legality of gambling in various jurisdictions. In another example, the betting card may comprise a game in which the users compete in order to win the value associated with the betting card, which may be added by one or more of the users and/or by some other entity that may provide the betting card.

A moblet may be created by a user of a moblet client 102 based at least in part upon pre-defined moblet templates. In this regard, a moblet template may be accessed from a moblet template provider, such as a moblet service provider 104. The moblet template may define a structure for an embodiment of a moblet and allow for a user to define rules for the moblet, add value to the moblet, and/or otherwise customize the moblet template.

A “moblet issuer” may be regarded as an entity that defines a moblet and/or a specially defined moblet template. In this regard, a moblet issuer may be a goods or services provider that defines a moblet or moblet template and distributes that moblet or moblet template to end user customers.

All of the moblets, moblet service providers, moblet clients, and users comprise the system 100. Referring now to FIG. 1, the system 100 may include a moblet client 102, moblet service provider 104, and a remote moblet client 106 configured to communicate over a network 108. The network 108 may comprise one or more wireless networks, wireline networks, cellular networks, or combination thereof. In an exemplary embodiment, the network 108 may be embodied as or comprise the internet. It will be appreciated that while FIG. 1 illustrates only a single moblet client 102, moblet service provider 104, and remote moblet client 106, the system 100 may comprise multiple moblet clients 102, moblet service providers 104 and/or remote moblet clients 106

The moblet client 102 may be embodied as any computing device, mobile or fixed, and accordingly may be embodied as a server, desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like. The moblet client 102 may comprise a computing device operated by a goods or services provider that may be used for creation and/or distribution of moblets to remote moblet clients 106 such that users of remote moblet clients 106 may use or otherwise consume the moblets so as to redeem the moblets for goods or services that may be provided by the goods or services provider operating the moblet client 102. Additionally or alternatively, a moblet client 102 may be an end user device configured to create, distribute, and/or consume moblets, such as with the assistance of the moblet service provider 104. In this regard, a moblet client 102 may comprise one embodiment of a remote moblet client 106. Accordingly, a remote moblet client 106 may be embodied as an end user device configured to use moblets and may comprise a moblet client unit 118.

The moblet client 102 may include various means, such as a processor 110, memory 112, communication interface 114, user interface 116, and moblet client unit 118 for performing the various functions herein described. These means of the moblet client 102 as described herein may be embodied as, for example, hardware elements (e.g., a suitably programmed processor, combinational logic circuit, and/or the like), computer code (e.g., software or firmware) embodied on a computer-readable medium (e.g. memory 112) that is executable by a suitably configured processing device (e.g., the processor 110), or some combination thereof. The processor 110 may, for example, be embodied as various means including a microprocessor, a coprocessor, a controller, or various other processing elements including integrated circuits such as, for example, an ASIC (application specific integrated circuit) or FPGA (field programmable gate array). In an exemplary embodiment, the processor 110 may be configured to execute instructions stored in the memory 112 or otherwise accessible to the processor 110. Although illustrated in FIG. 1 as a single processor, the processor 110 may comprise a plurality of processors, which may operate cooperatively. In this regard, functionalities described herein as being performed or controlled by the processor 110 may be performed by one or more of a plurality of processors.

The memory 112 may include, for example, volatile and/or non-volatile memory. The memory 112 may be configured to store information, data, applications, instructions, or the like for enabling the moblet client 102 to carry out various functions in accordance with exemplary embodiments of the present invention. For example, the memory 112 may be configured to buffer input data for processing by the processor 110. Additionally or alternatively, the memory 112 may be configured to store instructions for execution by the processor 110. The memory 112 may comprise one or more databases that store information in the form of static and/or dynamic information. In this regard, the memory 112 may store, for example, moblets, customized moblet templates, information about moblet usage, and/or links to access moblets. This stored information may be stored and/or used by the moblet client unit 118 during the course of performing its functionalities.

The communication interface 114 may be embodied as any device or means embodied in hardware, software, firmware, or a combination thereof that is configured to receive and/or transmit data from/to a network, such as the network 108, and/or any device, such as a moblet service provider 104 and/or remote moblet client 106, in communication with the moblet client 102. In one embodiment, the communication interface 114 may be at least partially embodied as or otherwise controlled by the processor 110. The communication interface 114 may include, for example, an antenna, a transmitter, a receiver, a transceiver and/or supporting hardware or software for enabling communications with other entities of the system 100. The communication interface 114 may be configured to receive and/or transmit data using any protocol that may be used for communications between the moblet client 102 and other computing devices of the system 100. The communication interface 114 may additionally be in communication with the memory 112, user interface 116, and/or moblet client unit 118, such as via a bus.

The user interface 116 may be in communication with the processor 110 to receive an indication of a user input and/or to provide an audible, visual, mechanical, or other output to the user. As such, the user interface 116 may include, for example, a keyboard, a mouse, a joystick, a display, a touch screen display, a microphone, a speaker, and/or other input/output mechanisms. However, in embodiments wherein the moblet client 102 is embodied as a server, such as, for example, a server operated by a retail services provider for distributing moblets to end users, elements of the user interface may be reduced or even eliminated. The user interface 116 may further be in communication with the memory 112, communication interface 116, and/or moblet client unit 118, such as via a bus.

The moblet client unit 118 may be embodied as various means, such as hardware, software, firmware, or some combination thereof and, in one embodiment, may be embodied as or otherwise controlled by the processor 110. In embodiments where the moblet client unit 118 is embodied separately from the processor 110, the moblet client unit 118 may be in communication with the processor 110.

The moblet client unit 118 may be configured to access a moblet template from a moblet service provider 104 and define customizations to the moblet template so as to define a lower level, more specialized moblet template and/or a moblet. In this regard, the moblet client unit 118 may be configured to access a moblet service provider 104 and select a moblet template available from the moblet service provider 104. The moblet client unit 118 may then be configured to receive a copy of the selected moblet template from the moblet service provider 104 such that the selected moblet template may be locally customized on the moblet client 102. Additionally or alternatively, the moblet client unit 118 may be configured to receive access to a remotely stored copy of the selected moblet template such that the selected moblet template may be customized by sending an indication of one or more customizations of the selected moblet template to the moblet service provider 104. As described above, a moblet template may comprise a generic-purpose template, a specific purpose template (e.g., a gift card template or betting card template), or a partially customized template (e.g., a template already partially customized, such as by a vendor of services or goods).

The moblet client unit 118 may be configured to customize the moblet template so as to define a more specific-purpose moblet template and/or a moblet in a number of ways. The customizations may be based at least in part upon user selections received by the moblet client unit 118 over the user interface 116. Additionally or alternatively, the customizations may be based at least in part upon predefined preferences, such as, for example, customization rules, data about user preferences for moblet template customization, and/or data about a user's moblet usage history, which may be stored in the memory 112. In this regard, the moblet client unit 118 may be configured to at least partially customize the moblet template without user intervention based at least in part upon the predefined preferences. The moblet client unit 118 may further be configured to take into account a type and/or source of the moblet template when automatically customizing the moblet template.

As mentioned, the moblet client unit 118 may be configured to customize, such as based on user selections and/or automatically based upon predefined preferences, a moblet template in a number of ways. For example, the moblet client unit 118 may be configured to add a rule to the moblet template and/or to modify an existing rule of the moblet template. Such rules may include, for example, a betting rule, a rule defining a time period(s) and/or location(s) at which the moblet may be activated (e.g., used), a rule defining who may add value to the moblet, a rule defining who may activate the moblet (e.g., a beneficiary), and/or the like. The moblet client unit 118 may be configured to define users who may add value to the moblet and/or activate the moblet by selecting one or more users from a list of contacts that may be stored in the memory 112. Customizations may additionally or alternatively comprise adding or amending a personal message (e.g., text or audio message), picture(s), video(s), and/or advertisement carried by the moblet. Such messages, pictures, and/or videos may be captured by the moblet client 102, such as in embodiments wherein the moblet client 102 is embodied as a mobile terminal comprising an image capture device (e.g., a camera). The moblet client unit 118 may be configured to customize the moblet template by adding service or product information, which may define products or services that the moblet may be used to redeemed for and/or products or services that the moblet may not be redeemed for. In this regard, for example, a moblet template may be customized such that a moblet may be redeemed for all products offered by a particular vendor except for alcoholic beverages. The moblet client unit 118 may further be configured to sign a moblet with a device specific identifier or key so as to identify the source of the customized moblet.

The moblet client unit 118 may be configured to add value to a moblet. This value may comprise monetary value, customer rewards points (e.g., loyalty points, frequent flyer miles, and/or the like), and/or the like. The value may be added by credit card, an electronic deposit account or banking service (e.g. an electronic bill pay service, PayPal™, and/or the like), by an electronic wallet, by charging a customer account that may be held by a user of the moblet client 102, by a mobile service operator, and/or the like. The moblet client 118 may further be configured to receive an indication of value added to a moblet by a moblet service provider 104 and/or a remote moblet client 106 and may, if appropriate, update a locally stored copy of the moblet based upon the received indication.

In some embodiments, the moblet client unit 118 may be configured to send information on a customized moblet template and/or moblet to other devices of the system 100, such as the moblet service provider 104, and/or a remote moblet client 106 which may comprise a moblet template provider, moblet template owner, a moblet service provider, or a moblet issuer. The information may comprise a customized moblet template itself, information about value added to a moblet or moblet template, and/or information about customizations made to the original moblet template.

The moblet client unit 118 may be configured to share and/or otherwise provide customized moblet templates and/or moblets to other devices of the system 100, such as a moblet service provider 104 and/or remote moblet clients 106. The moblet client unit 118 may, for example send a customized moblet template or moblet to the moblet service provider 104. In this regard, the moblet service provider 104 may be configured to store, distribute, and/or manage the customized moblet template or moblet for use by devices of the system 100. Additionally or alternatively, the moblet client unit 118 may be configured to provide a customized moblet template and/or moblet to other devices of the system 100, such as a remote moblet client 106, such that devices may access and/or download the customized moblet template or moblet from the moblet client 102. For example, a moblet and/or a link thereto may be placed on a web page such that a user of a remote moblet client 106 may access the moblet from the moblet client 102. In some embodiments, the moblet client unit 118 may be configured to provide customized moblet templates and/or moblets to remote moblet clients 106 through peer-to-peer sharing and/or broadcasting/multicasting.

The moblet client unit 118 may further be configured to receive an update to a moblet and/or moblet template, such as from a remote moblet client 106 or a moblet service provider 104. The update may comprise customizations made to a moblet template and/or value added to a moblet by a user(s) of the system 100. The update may comprise a message, link, and/or advertisement added to a moblet by a moblet issuer (e.g., a goods or services provider who may have defined either the moblet itself or a moblet template based upon which the moblet was defined). The update may comprise, for example, product news or an offer to the moblet holder. The update may comprise an update based upon a rule of the moblet, such as, for example, an update based upon a betting rule in embodiments wherein the moblet is a betting card. The update may comprise moblet usage information, such as in response to activation of a moblet by a beneficiary of the moblet.

In another example, the moblet client unit 118 may be configured to receive an update to a moblet based upon a user's participation in a rewards system, such as may be administered by a moblet service provider 104. For example, a user of the system 100 may be rewarded for sending a moblet to another user (e.g., to a remote moblet client 106) who then uses the moblet. Accordingly, the moblet client 118 may receive an update to the moblet, which may comprise an addition of value to the moblet, as a reward for active participation in the rewards system.

In an exemplary embodiment, the moblet client unit 118 may be configured to monitor actions of the moblet client 102 and/or of a user of a moblet client 102. For example, the moblet client unit 118 may monitor a current location of the moblet client 102 and/or a history of locations at which the moblet client 102 has been located. In another example, the moblet client unit 118 may monitor usage of moblets by a user of the moblet client 102. The moblet client unit 118 may be configured to send information about the monitored actions to the moblet service provider 104 and/or a remote moblet client 106, such as, based upon rules defined by a moblet. This moblet client unit 118 may be configured to aggregate and/or process the information prior to sending it to a remote device. In this regard, the moblet client unit 118 may locally enforce privacy policies and/or user preferences for the sharing of information with remote devices, such as, for example, a moblet service provider 104 or remote moblet client 106. The information may be used by the receiving devices to update copies of the moblet stored on the receiving devices. The moblet client unit 118 may be configured to update a moblet based at least in part upon the monitored actions, such as according to rules defined by the moblet. For example, a moblet may have a rule defining that the moblet may only be activated (e.g., used) in a defined location and/or at a defined time. Accordingly, when the moblet client 102 is located at the defined location and/or the current time is the defined time, the moblet client unit 118 may be configured to update the moblet so that it may be activated.

In embodiments wherein the moblet client 102 is embodied as an end user device (e.g., a remote moblet client), the moblet client unit 118 may be configured to activate a moblet. A moblet may be activated based at least in part upon a rule of the moblet, a received update, actions of a user of the moblet client 102 (e.g., selection of a moblet for activation by the user using the user interface 116), and/or actions of the moblet client 102. Activation of the moblet may comprise exchanging value embodied on the moblet for a good or service from a good or service provider, which may be the issuer of the moblet.

Further, in embodiments wherein the moblet client 102 is embodied as an end user device (e.g., a remote moblet client), the moblet client unit 118 may be configured to receive a moblet from a remote device, such as, for example, from a moblet service provider 104 and/or a remote moblet client 106. In this regard, the moblet client unit 118 may be configured to receive a moblet, for example, from a remote moblet client 106 via a peer-to-peer transfer, download a moblet from a moblet service provider 104 (e.g., from a web page), and/or the like. Depending on rules defined by the received moblet, the moblet client unit 118 may be configured to open the received moblet and display moblet information to a user of the moblet client 102, customize the moblet, add value to the received moblet, receive an update to the moblet, provide the received moblet to other devices or users, and/or activate the received moblet. The moblet client unit 118 may be configured to send information about customizations made to and/or value added to the received moblet to a remote moblet client 106 or moblet service provider 104, which may comprise a moblet template provider, moblet template owner, a moblet service provider, or a moblet issuer. The moblet client unit 118 may further be configured to combine multiple moblets into a single moblet, such as by aggregating values embodied on each moblet into a single moblet. The moblet client unit 118 may further be configured to split one moblet into multiple moblets, such as by splitting the value embodied in the moblet into multiple moblets.

The moblet service provider 104 may be embodied as any computing device configured to provide moblet templates and/or moblets to computing devices of the system 100 as well as management services related thereto. The moblet service provider 104 may comprise a computing device or plurality of computing devices operated by a provider of moblet templates and/or an issuer of moblets. Access to the moblet service provider 104 may be managed by and/or acquired through an account management provider entity (not illustrated in FIG. 1, but may be part of the system 100), such as, for example, Nokia's www.ovi.com. Such an account management provider may serve as an integrated portal to a plurality of services, which may include moblet services offered by a moblet service provider 104. The account management provider may provide universal user authentication, billing, and/or accounting services, which may include value embodied on moblet(s) possessed by a user, across the plurality of services.

The moblet service provider 104 may include various means, such as a processor 120, memory 122, communication interface 124, user interface 126, and moblet services unit 128 for performing the various functions herein described. These means of the moblet service provider 104 as described herein may be embodied as, for example, hardware elements (e.g., a suitably programmed processor, combinational logic circuit, and/or the like), computer code (e.g., software or firmware) embodied on a computer-readable medium (e.g. memory 122) that is executable by a suitably configured processing device (e.g., the processor 120), or some combination thereof. The processor 120 may, for example, be embodied as various means including a microprocessor, a coprocessor, a controller, or various other processing elements including integrated circuits such as, for example, an ASIC (application specific integrated circuit) or FPGA (field programmable gate array). In an exemplary embodiment, the processor 120 may be configured to execute instructions stored in the memory 122 or otherwise accessible to the processor 120. Although illustrated in FIG. 1 as a single processor, the processor 120 may comprise a plurality of processors, which may operate cooperatively, and in some embodiments at least some of the plurality of processors may operate in parallel. The plurality of processors may be embodied on a single computing device or may be embodied on a plurality of computing devices operating cooperatively, such as, for example, a server cluster or a rack of blade servers. In this regard, functionalities described herein as being performed or controlled by the processor 120 may be performed by one or more of a plurality of processors.

The memory 122 may include, for example, volatile and/or non-volatile memory. The memory 122 may be configured to store information, data, applications, instructions, or the like for enabling the moblet service provider 104 to carry out various functions in accordance with exemplary embodiments of the present invention. For example, the memory 122 may be configured to buffer input data for processing by the processor 120. Additionally or alternatively, the memory 122 may be configured to store instructions for execution by the processor 120. The memory 122 may comprise one or more databases that store information in the form of static and/or dynamic information. In this regard, the memory 122 may store, for example, moblet templates, customized moblet templates, moblets, information about moblets, moblet user data, and/or information about moblet usage. This stored information may be stored and/or used by the moblet services unit 128 during the course of performing its functionalities.

The communication interface 124 may be embodied as any device or means embodied in hardware, software, firmware, or a combination thereof that is configured to receive and/or transmit data from/to a network, such as the network 108, and/or any device, such as a moblet client 102 and/or remote moblet client 106, in communication with the moblet service provider 104. In one embodiment, the communication interface 124 may be at least partially embodied as or otherwise controlled by the processor 120. The communication interface 124 may include, for example, an antenna, a transmitter, a receiver, a transceiver and/or supporting hardware or software for enabling communications with other entities of the system 100. The communication interface 124 may be configured to receive and/or transmit data using any protocol that may be used for communications between the moblet service provider 104 and other computing devices of the system 100. The communication interface 124 may additionally be in communication with the memory 122, user interface 126, and/or moblet services unit 128, such as via a bus.

The user interface 126 may be in communication with the processor 120 to receive an indication of a user input and/or to provide an audible, visual, mechanical, or other output to the user. As such, the user interface 126 may include, for example, a keyboard, a mouse, a joystick, a display, a touch screen display, a microphone, a speaker, and/or other input/output mechanisms. However, in embodiments wherein the moblet service provider 103 is embodied as a server, elements of the user interface may be reduced or even eliminated. The user interface 126 may further be in communication with the memory 122, communication interface 126, and/or moblet services unit 128, such as via a bus.

The moblet services unit 128 may be embodied as various means, such as hardware, software, firmware, or some combination thereof and, in one embodiment, may be embodied as or otherwise controlled by the processor 120. In embodiments where the moblet services unit 128 is embodied separately from the processor 120, the moblet services unit 128 may be in communication with the processor 120. The moblet services unit 128 may be configured to serve as a portal to users of moblet clients 102 and/or remote moblet clients 106 for usage of the system 100. In this regard, the moblet services unit 128 may be configured to maintain, such as in memory 112 of statistics as well as other data per user of the system 100 for moblet creation, consumption, and/or distribution by users. Users of the system 100 may comprise, for example, moblet end users (e.g., consumers), advertisers, vendors, and/or the like. The moblet services unit 128 may utilize this maintained data to provide user-specific services and data to users accessing moblet portal services provided by the moblet services unit 128. For example, the moblet services unit 128 may be configured to host and/or provide on demand, user specific pages (e.g., a web page) showing user specific moblet data. For example, for an end user, such a page may provide information about moblet usage, availability, distribution history, contacts, and/or the like. For a vendor or advertiser, such a page may provide information about moblets and moblet templates created and/or provided by the user, distribution history, usage of the moblets by end users who have accessed the moblets, and/or the like.

The moblet services unit 128 may be configured to provide access to a plurality of moblet templates to moblet clients 102. The moblet services unit 128 may receive an indication of a requested moblet template from a moblet client 102 and then provide access to the requested moblet template to the requesting moblet client 102. In this regard, the moblet services unit 128 may be configured to send the requesting moblet client 102 a copy of the moblet template that the moblet client 102 may customize at the moblet client 102. The moblet services unit 128 may be configured receive a customized moblet and/or customized moblet template, which represents a customized copy of the moblet template sent to the requesting moblet client 102, from the requesting moblet client 102. The moblet services unit 128 may store a received customized moblet or customized moblet template in the memory 122 from where it may be accessed by moblet clients 102 and/or remote moblet clients 106. Additionally or alternatively, in some embodiments, the moblet services unit 128 may be configured to provide the requesting moblet client 102 access to a locally stored copy of the moblet template, such as over a web interface, so that the requesting moblet client 102 may customize the local moblet template. In such embodiments, the moblet services unit 128 may be configured to receive an indication of customizations made to the moblet template from the moblet client 102 and customize the moblet template to define either a moblet or a customized moblet template based at least in part upon the received indication. The moblet service provider 104 may further be configured to receive an indication of value added to a moblet and to add the value to the moblet.

In some embodiments, the moblet services unit 128 may be configured to provide a moblet customized by a moblet client 102 to remote devices of the system 100, such as, for example, a moblet client 102 and/or a remote moblet client 106. In this regard, the moblet services unit 128 may be configured to send a moblet to a remote device in response to a request received from the remote device. The moblet services unit 128 may be configured to provide a moblet by providing access to the moblet, such as over a web interface. In some embodiments, the moblet services unit 128 may be configured to send and/or suggest moblets to remote moblet clients 106 based at least in part upon a user's preferences and/or moblet usage history. Accordingly, the moblet services unit 128 may be configured to store moblet usage history (e.g., history of customizing moblet templates, download of moblets, activation of moblets, sharing of moblets, and/or the like) in a memory, such as the memory 122.

The moblet services unit 128 may further be configured to receive an update to a moblet. The moblet services unit 128 may be configured to update the moblet based at least in part upon the received update. In this regard, the moblet services unit 128 may be configured to update a locally stored moblet, such as may be stored in memory 122, and/or may be configured to send an update to a remote device, such as a moblet client 102 or a remote moblet client 106 so that the remote device may update a moblet stored on the remote device. In an exemplary embodiment, the moblet services unit 128 may be configured to provide moblet synchronization services. In this regard, for example, if an update to a parent moblet template is received, all child moblets or child customized moblet templates that were defined based upon the parent moblet template, may be updated so as to inherit updates made to the parent moblet template. In another example, if an update is received to a moblet, for which cloned copies are dispersed among a plurality of moblet clients 102 and/or remote moblet clients 106, the moblet services unit 128 may be configured to send the received update to all remote devices on which the moblet is embodied. If the only physical copy of the moblet is stored locally, the moblet services unit 128 may be configured to send notice of an update to the moblet to moblet clients 102 or remote moblet clients 106 that have stored references to the moblet (e.g., devices that have received and/or obtained a moblet by saving a reference to the moblet but not by downloading a physical copy of the moblet).

The moblet services unit 128 may receive an update and/or be configured to update a moblet based at least in part upon a rule of the moblet, such as, for example, a betting rule that may define a “winner” of value embodied on a moblet in response to the occurrence of an event. The moblet services unit 128 may further be configured to add value to a moblet. This value may be added unilaterally, such as automatically based upon a rule, or in response to a received user request or indication of a user adding value to a moblet at a moblet client 102. The moblet services unit 128 may be configured to receive information about user actions and/or actions of a moblet client 102 and may update a moblet and/or send an update to a moblet to remote devices based at least in part upon the received information. This information may be aggregated and/or processed at the moblet client 102 prior to receipt by the moblet services unit 128. In this regard, the moblet client 102 may locally enforce privacy policies and/or user preferences for the sharing of information with the moblet service provider 104. In another example, the moblet services unit 128 may be configured to administer a rewards system. For example, a user of the system 100 may be rewarded for sending a moblet to another user who then uses the moblet. Thus, the moblet services unit 128 may be configured to maintain data on moblets sent by users of the system 100 and activation or consumption thereof by the receiving users. The moblet services unit 128 may update the sending user's moblet, such as by adding value to the moblet, as a reward for active participation in the rewards system. The moblet services unit 128 may administer such a rewards system using information maintained and stored on moblet usage and sharing by users of the system 100.

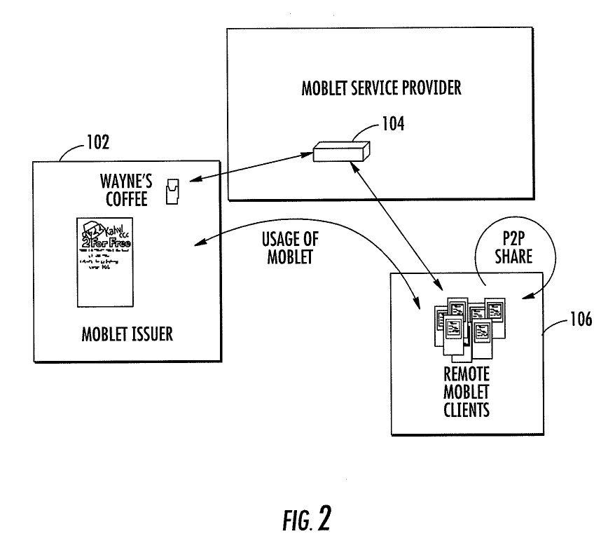

FIG. 2 illustrates an exemplary embodiment of the system of FIG. 1. In FIG. 2, the moblet client 102 is embodied as the vendor “Wayne's Coffee,” which may be a moblet issuer. In this regard, Wayne's Coffee may access a moblet template from the moblet service provider 104 and customize the template to define a gift card moblet with a rule defining that the gift card may be used to purchase products from Wayne's Coffee. The customized moblet may be stored on the moblet service provider 104 and a remote moblet client 106 may download and access the moblet. The remote moblet client 106 may then share the moblet with other remote moblet clients 106, such as through peer-to-peer sharing. A remote moblet client 106 having the moblet may activate the moblet and Wayne's Coffee and/or the Moblet service provider 104 may receive notice of usage of the moblet.

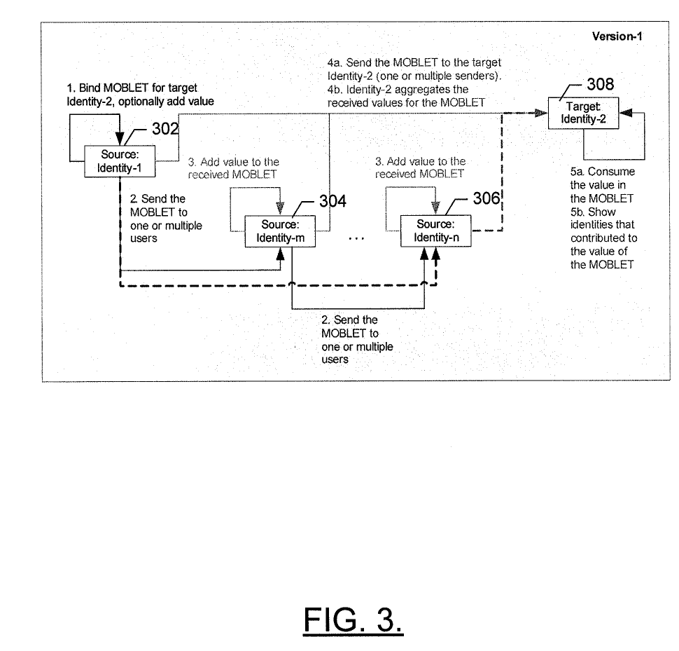

FIG. 3 illustrates a method of multiple users contributing value to a moblet according to an exemplary embodiment of the present invention. In this regard, a moblet client 102 (“Source identity-1”) may define a moblet and customize the moblet with a rule defining a beneficiary (“Target identity-2”) and may also define one or more users who may add value to the moblet, at operation 302. The moblet client 102 may then send the moblet to a remote moblet client 106 associated with the beneficiary and/or one or more remote moblet clients 106 associated with the users who may contribute value to the moblet. Operations 304 and 306 illustrate the addition of value to the moblet by users of remote moblet clients 106. The value may be added in a peer-to-peer manner and/or may be managed by the moblet services unit 128, which may receive an indication from each remote moblet client 106 an indication of value added to the moblet and may then add value to the moblet based upon the received indications. Operation 308 illustrates the activation, e.g., consumption, by the remote moblet client 106 associated with the beneficiary of the moblet having a value represented by the aggregation of all values contributed in operations 302-306.

In an exemplary embodiment, the system 100 may provide moblet group services. In this regard, the moblet services unit 128 may be configured to rank and/or categorize users of the moblets system based at least in part upon their moblet usage (e.g., frequency of moblet usage, quantity of moblet usage, types/categories of moblets downloaded and/or activated, and/or the like). The moblet services unit 128 may be configured to recommend and/or provide suggested moblets to users (e.g., to their moblet clients) based at least in part upon the ranking or categorization of the users. In some embodiments, the moblet services unit 128 may be configured to form groups of users and recommend suggested contacts and/or groups of contacts to users based at least in part upon the ranking or categorization of moblet usage by a user. As used herein, a “contact” may comprise any user of the system 100 and may not be previously known to a user to whom a contact is suggested. In this regard, the moblet services unit 128 may be configured to suggest contacts having similar moblet usage patterns to the user or a group comprised of contacts having similar moblet usage patterns to the user. These suggested contacts or groups may facilitate interaction across the system so that users may provide and receive moblet recommendations and/or moblets based upon the user's personal preferences. This may encourage heightened moblet usage across the system 100. The suggested contacts or groups of contacts may comprise contacts stored in a user's contacts list (e.g., contacts known to the user for whom contact information, such as, for example, a phone book, may be defined in a contacts list that may be stored in the memory 112 and/or in the memory 122). In some embodiments, the moblet services unit 128 may be configured to suggest contacts not in a user's contacts list, but the pool of potential contacts that the moblet services unit 128 may suggest may be limited by a degree of separation between the contact and the user. For example, the moblet services unit 128 may be configured to suggest contacts of contacts of the user (e.g., two degrees of separation), but not contacts of contacts of contacts of the user (e.g., three degrees of separation). In this regard, a user may have a higher trust of friends of friends, but may not trust or be interested in moblet preferences of users of the system with a more remote connection to the user. In some embodiments, so as to address privacy concerns, a user may be able to configure the moblet client unit 118 and/or user preferences managed by the moblet services unit 128 to limit information shared about the user's moblet usage and/or to customize the recommendation of groups or contacts to the user.

In some embodiments, the above described suggestion of moblets, contacts, and/or groups may be performed at the moblet client 102, such as by the moblet client unit 118. In this regard, the moblet services unit 128 may be configured to provide the moblet client 102 with information about available moblets, contacts, and/or groups and the moblet client unit 118 may be configured to filter the received information, such as based on user history and/or predefined preferences so as to suggest moblets, contacts, and/or groups to a user of the moblet client 102. The moblet services unit 128 may be configured to provide the information to the moblet client unit 118 as an information feed, such as in the form of a Really Simple Syndication (RSS) feed. This information provided by the moblet services unit 128 may be raw, e.g., unfiltered, or may be partially filtered by the moblet services unit, such as based upon country, state, city, age, gender, sex, and/or the like. In this regard, user preferences and/or history may be maintained at the moblet client 102 for purposes of providing suggestions so as to protect user privacy.

Some embodiments of the system 100 may facilitate suggestion of moblets, contacts, and/or groups through peer-to-peer services. In this regard, suggestion functions need not be centralized in the moblet service provider 104 and the moblet client unit 118 may be configured to share information (e.g., about available moblets, contacts, and/or groups) with and receive information from remote moblet clients 106. Such peer-to-peer functionality may facilitate scalability of group and suggestion services. Results of peer-to-peer contact, group, or moblet creation may be signaled back to the moblet service provider 104, which may maintain data regarding available moblets, contacts, and/or groups.

In some embodiments, the moblet services unit 128 may be configured to receive and maintain user rankings of moblets. In this regard, a user may further define types or categories of moblets that the user is interested and the moblet services unit 128 may be configured to use the rankings to refine moblets, contacts, and/or groups suggested to the user.

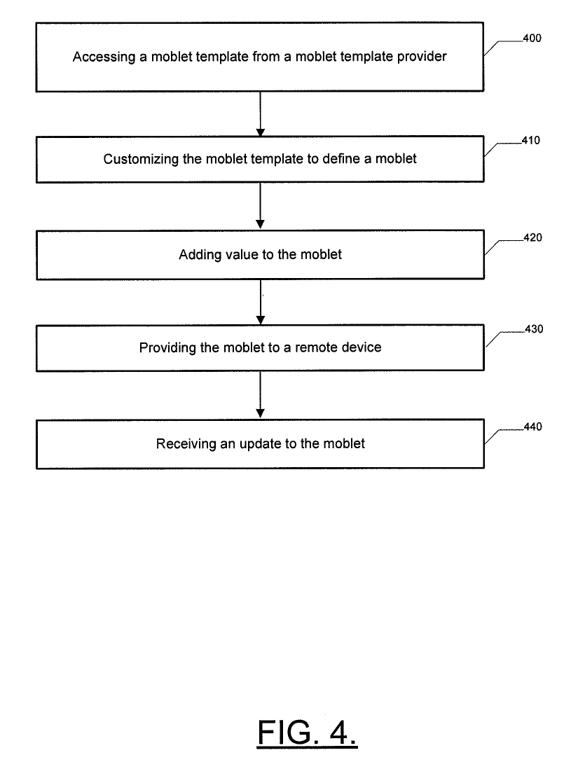

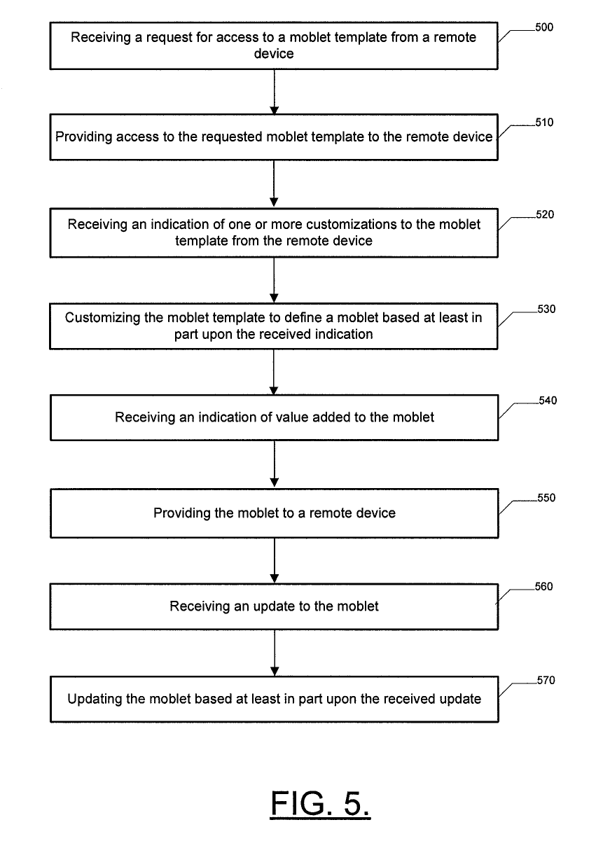

FIGS. 4-5 are flowcharts of systems, methods, and computer program products according to an exemplary embodiment of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for defining an electronic value certificate, such as a moblet, according to an exemplary embodiment of the present invention is illustrated in FIG. 4. In this regard, FIG. 4 illustrates operations that may take place on a moblet client 102. The method may include the moblet client unit 118 accessing a moblet template from a moblet template provider, such as a moblet service provider 104, at operation 400. Operation 410 may comprise the moblet client unit 118 customizing the moblet template to define a moblet. The moblet client unit 118 may then add value to the moblet, at operation 420. Operation 430 may comprise the moblet client unit 118 providing the moblet to a remote device, such as a moblet service provider 104 or a remote moblet client 106. The moblet client unit 118 may then receive an update to the moblet, such as from a moblet service provider 104 or from a remote moblet client 106, at operation 440.

FIG. 5 illustrates an exemplary method for defining an electronic value certificate, such as a moblet, according to an exemplary embodiment of the present invention. In this regard, FIG. 5 illustrates operations that may take place at a moblet service provider 104. The method may include the moblet services unit 128 receiving a request for access to a moblet template from a remote device, such as a moblet client 102 or remote moblet client 106, at operation 500. Operation 510 may comprise the moblet services unit 128 providing access to the requested moblet template to the remote device. The moblet services unit 128 may then receive an indication of one or more customizations to the moblet template from the remote device, at operation 520. Operation 530 may comprise the moblet services unit 128 customizing the moblet template to define a moblet based at least in part upon the received indication. The moblet services unit 128 may then receive an indication of value added to the moblet (and may, if necessary, update the moblet to reflect the added value), at operation 540. Operation 550 may comprise the moblet services unit 128 providing the moblet to a remote device, such as a moblet client 102 or a remote moblet client 106. The moblet services unit 128 may then receive an update to the moblet, at operation 560, and update the moblet based at least in part upon the received update, at operation 570.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal. Embodiments of the invention may provide for the creation and sharing of electronic value certificates, which may be embodied as moblets as described herein. Users may be able to customize moblet templates and share moblets across a community. A moblet may allow for multiple users to contribute value to a moblet. Systems according to some embodiments of the invention may allow for recommending moblets, contacts, and/or groups of contacts to a user based at least in part upon the user's previous moblet usage.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
accessing a moblet template from a moblet template provider;
customizing the moblet template to define a moblet;
adding value to the moblet;
providing the moblet to a remote device; and
receiving an update to the moblet.

2. A method according to claim 1, further comprising:
monitoring one or more of user actions or actions of a device on which the moblet is embodied; and
updating the moblet based at least in part upon the monitored actions.

3. A method according to claim 1, further comprising activating the moblet such that at least a portion of the value of the moblet is redeemed based at least in part upon one or more of the received update, user actions, or actions of a device on which the moblet is embodied.

4. A method according to claim 1, wherein:
customizing the moblet template comprises adding a betting rule to the moblet template to define a betting card;
providing the moblet to a remote device comprises providing the betting card to a remote device; and
receiving an update to the moblet comprises receiving an update to the betting card based at least in part upon the betting rule.

5. A method according to claim 1, wherein receiving an update to the moblet comprises receiving an update to the value of the moblet based at least in part upon addition of value to the moblet by a user of the remote device.

6. A method according to claim 1, further comprising sending information about the moblet to a remote device.

7. A method according to claim 1, wherein customizing the moblet template comprises defining a rule for use of the moblet.

8. A method according to claim 7, wherein receiving an update to the moblet comprises receiving the update based at least in part upon the rule.

9. A method according to claim 1, further comprising receiving information about moblet usage of a contact.

10. A method according to claim 1, further comprising receiving a suggested contact or a suggested group from a moblet service provider based at least in part upon moblet usage of one or more contacts.

11. A method comprising:
receiving a request for access to a moblet template from a remote device;
providing access to the requested moblet template to the remote device;
receiving an indication of one or more customizations to the moblet template from the remote device;
customizing the moblet template to define a moblet based at least in part upon the received indication;
receiving an update to the moblet; and
updating the moblet based at least in part upon the received update.

12. A method according to claim 11, further comprising:
receiving an indication of value added to the moblet; and
providing the moblet to a remote device.

13. A computer program product comprising at least one computer-readable storage medium having computer-readable program instructions stored therein, the computer-readable program instructions comprising:
a first program instruction for accessing a moblet template from a moblet template provider;
a second program instruction for customizing the moblet template to define a moblet;
a third program instruction for adding value to the moblet;
a fourth program instruction for providing the moblet to a remote device; and
a fifth program instruction for receiving an update to the moblet.

14. A computer program product according to claim 13, further comprising:
a sixth program instruction for monitoring one or more of user actions or actions of a device on which the moblet is embodied; and
a seventh program instruction for updating the moblet based at least in part upon the monitored actions.

15. A computer program product according to claim 13, further comprising a sixth program instruction for activating the moblet such that at least a portion of the value of the moblet is redeemed based at least in part upon one or more of the received update, user actions, or actions of a device on which the moblet is embodied.

16. A computer program product according to claim 13, wherein:
the second program instruction includes instructions for adding a betting rule to the moblet template to define a betting card;
the fourth program instruction includes instructions for providing the betting card to a remote device; and
the fifth program instruction includes instructions for receiving an update to the betting card based at least in part upon the betting rule.

17. A computer program product according to claim 13, wherein the second program instruction includes instructions for defining a rule for use of the moblet.

18. A computer program product according to claim 17, wherein the fifth program instruction includes instructions for receiving an update to the moblet based at least in part upon the rule.

19. A computer program product comprising at least one computer-readable storage medium having computer-readable program instructions stored therein, the computer-readable program instructions comprising:
a first program instruction for receiving a request for access to a moblet template from a remote device;
a second program instruction for providing access to the requested moblet template to the remote device;
a third program instruction for receiving an indication of one or more customizations to the moblet template from the remote device;
a fourth program instruction for customizing the moblet template to define a moblet based at least in part upon the received indication;
a fifth program instruction for receiving an update to the moblet; and
a sixth program instruction for updating the moblet based at least in part upon the received update.

20. A computer program product according to claim 19, further comprising:
a seventh program instruction for receiving an indication of value added to the moblet; and
an eighth program instruction for providing the moblet to a remote device.

21. An apparatus comprising a processor configured to:
access a moblet template from a moblet template provider;
customize the moblet template to define a moblet;
add value to the moblet;
provide the moblet to a remote device; and
receive an update to the moblet.

22. An apparatus according to claim 21, wherein the processor is further configured to:
monitor one or more of user actions or actions of a device on which the moblet is embodied; and
update the moblet based at least in part upon the monitored actions.

23. An apparatus according to claim 21, wherein the processor is further configured to activate the moblet such that at least a portion of the value of the moblet is redeemed based at least in part upon one or more of the received update, user actions, or actions of a device on which the moblet is embodied.

24. An apparatus according to claim 21, wherein the processor is configured to:
customize the moblet template by adding a betting rule to the moblet template to define a betting card;
provide the moblet to a remote device by providing the betting card to a remote device; and
receive an update to the moblet by receiving an update to the betting card based at least in part upon the betting rule.

25. An apparatus according to claim 21, wherein the processor is configured to receive an update to the moblet by receiving an update to the value of the moblet based at least in part upon addition of value to the moblet by a user of the remote device.

26. An apparatus according to claim 21, wherein the processor is further configured to send information about the moblet to a remote device.

27. An apparatus according to claim 21, wherein the processor is configured to customize the moblet template by defining a rule for use of the moblet.

28. An apparatus according to claim 27, wherein the processor is configured to receive an update to the moblet by receiving the update based at least in part upon the rule.

29. An apparatus according to claim 21, wherein the processor is further configured to receive information about moblet usage of a contact.

30. An apparatus according to claim 21, wherein the processor is further configured to receive a suggested contact or a suggested group from a moblet service provider based at least in part upon moblet usage of one or more contacts.

31. An apparatus according to claim 21, further comprising a memory, wherein the processor is further configured to store the moblet in the memory.

32. An apparatus comprising a processor configured to:
receive a request for access to a moblet template from a remote device;
provide access to the requested moblet template to the remote device;
receive an indication of one or more customizations to the moblet template from the remote device;
customize the moblet template to define a moblet based at least in part upon the received indication;
receive an update to the moblet; and
update the moblet based at least in part upon the received update.

33. An apparatus according to claim 32, further comprising a memory, wherein the processor is further configured to store the moblet in the memory.

34. An apparatus according to claim 32, wherein the processor is further configured to:
receive an indication of value added to the moblet; and
provide the moblet to a remote device.

35. An apparatus comprising:
means for accessing a moblet template from a moblet template provider;
means for customizing the moblet template to define a moblet;
means for adding value to the moblet;
means for providing the moblet to a remote device; and
means for receiving an update to the moblet.
